(19) United States
(12) Patent Application Publication
(10) Pub. No.: US 2012/0230045 A1
(43) Pub. Date: Sep. 13, 2012

(54) REARVIEW MIRROR

(75) Inventor: Shinya TAKAYANAGI, Fujieda-shi (JP)

(73) Assignee: MURAKAMI CORPORATION, Shizuoka (JP)

(21) Appl. No.: 13/351,502

(22) Filed: Jan. 17, 2012

(30) Foreign Application Priority Data
Mar. 11, 2011 (JP) 2011-054240

(51) Int. Cl. B60R 1/02

(52) U.S. Cl. 362/494

(57) ABSTRACT

An aspect of the present invention provides a rearview mirror designed to enhance assembly workability. When assembling a mirror unit of the rearview mirror, a lamp unit is dropped in an opening provided on a mirror holder from an inner surface side of the mirror holder in a condition in which side object detection symbols face upward. Thereafter, a circumferential edge of a reflective mirror is fitted into a recess-shaped fit portion of the mirror holder. The lamp unit is thus simply clamped and fixed between a lamp unit receiving portion (tab portions) and the reflective mirror. When the lamp unit is assembled in the mirror unit, therefore, adhesive is not used, so that workability is extremely good.

### BACKGROUND OF THE INVENTION

1. Field of the Invention

The present invention relates to a rearview mirror including a reflective mirror on which, for example, a warning is displayed.

2. Related Background Art

U.S. Pat. No. 6,264,353 is known as art in such a field. A rearview mirror disclosed in this publication includes a module (lamp unit) for making a reflective mirror display a turn signal. The module accommodates therein light-emitting diodes (LEDs) arrayed into a letter V. Tabs formed on the module are hooked through tab engagement onto snap retainers of a mirror holder for holding the reflective mirror. This results in the module being firmly fixed onto the mirror holder, so that a lens disposed in the module can be spaced apart from the reflective mirror.

### SUMMARY OF THE INVENTION

However, the lamp unit is required to be fixed onto the mirror holder through cooperation between the tabs and the snap retainers. This requires a step of fitting the lamp unit in the mirror holder, while positioning the lamp unit relative to the mirror holder, thus posing a problem of poor workability.

It is an object of the present invention to provide a rearview mirror designed to enhance assembly workability.

An aspect of the present invention provides a rearview mirror including: a mirror unit including a reflective mirror and a mirror holder disposed on the reflective mirror so as to cover a back surface of the reflective mirror in an inner surface side thereof; and a lamp unit including a light emitting section inside a housing. The mirror holder includes an opening portion in which the housing of the lamp unit is dropped from the inner surface side of the mirror holder and a lamp unit receiving portion disposed near the opening portion. The lamp unit is clamped and fixed between the lamp unit receiving portion and the reflective mirror. The lamp unit includes a cushion portion disposed on a light exit side, the cushion portion having a front surface pressed against the back surface of the reflective mirror by the mirror holder, and the front surface of the cushion portion is not provided with adhesive.

In this rearview mirror, the mirror holder includes the opening portion for allowing the housing of the lamp unit to be dropped in from the inner surface side of the mirror holder and the lamp unit receiving portion disposed near the opening portion. The lamp unit is clamped and fixed between the lamp unit receiving portion and the reflective mirror. During an assembly procedure, the lamp unit simply needs to be dropped into the opening portion formed in the mirror holder from the inner surface side of the mirror holder, so that workability is extremely good. Since the front surface of the cushion portion is not provided with adhesive, a situation can be prevented from occurring in which release paper is peeled off from the adhesive or the adhesive makes the lamp unit sticky to hands, which further improves assembly workability. Furthermore, since the lamp unit does not stick to the reflective mirror, reassembly sequence performed for the lamp unit relative to the mirror unit after inspection is made easy.

It is preferable that the reflective mirror include a half mirror portion, formed thereon, for transmitting light from the lamp unit, that the lamp unit include a display portion through which light transmits and the cushion portion be disposed so as to surround the display portion, and that the cushion portion be pressed against a back surface of the half mirror portion of the reflective mirror.

If the front surface of the cushion portion is provided with adhesive, the adhesive is to stick on the half mirror portion. Since the adhesive and the half mirror portion have different refractive indexes from each other, the adhesive is imaged on the half mirror portion because of an interference effect of light involved, so that the adhesive is visible from an outside through the half mirror portion. The application of the cushion portion having no adhesive on the front surface thereby prevents the above-described situation from occurring, which is optimum when the cushion portion is pressed against the half mirror portion. Furthermore, since the cushion portion surrounds the display portion through which light transmits, light can be reliably blocked and, moreover, water can be prevented from entering the display portion to thereby allow the cushion portion to offer a water stop effect. If the reflective mirror has a curved surface, the cushion portion can be easily made to conform to the curved surface.

Additionally, it is preferable that the lamp unit receiving portion on which a flange portion formed on the lamp unit touches correspond to an edge portion of the opening portion.

Such a lamp unit receiving portion can be said to be extremely simply arranged.

Additionally, it is preferable that the lamp unit receiving portion for supporting a bottom surface of the housing of the lamp unit protrude toward an outer surface side of the mirror holder as to be able to view from the opening portion.

Such a lamp unit receiving portion can be said to be simply arranged.

The aspect of the present invention can achieve improved assembly workability.

### BRIEF DESCRIPTION OF THE DRAWINGS

FIG. 1 is a perspective view showing a mirror unit applied to a rearview mirror according to a embodiment of the present invention.

FIG. 2 is an enlarged cross-sectional view showing a main part of the mirror unit.

FIG. 3 is an enlarged cross-sectional view showing a main part of another example of the mirror unit.

FIG. 4 is an enlarged cross-sectional view showing a main part of still another example of the mirror unit.

### DESCRIPTION OF THE PREFERRED EMBODIMENTS

A rearview mirror according to a preferred embodiment of the present invention will be described in detail below with reference to the drawings.

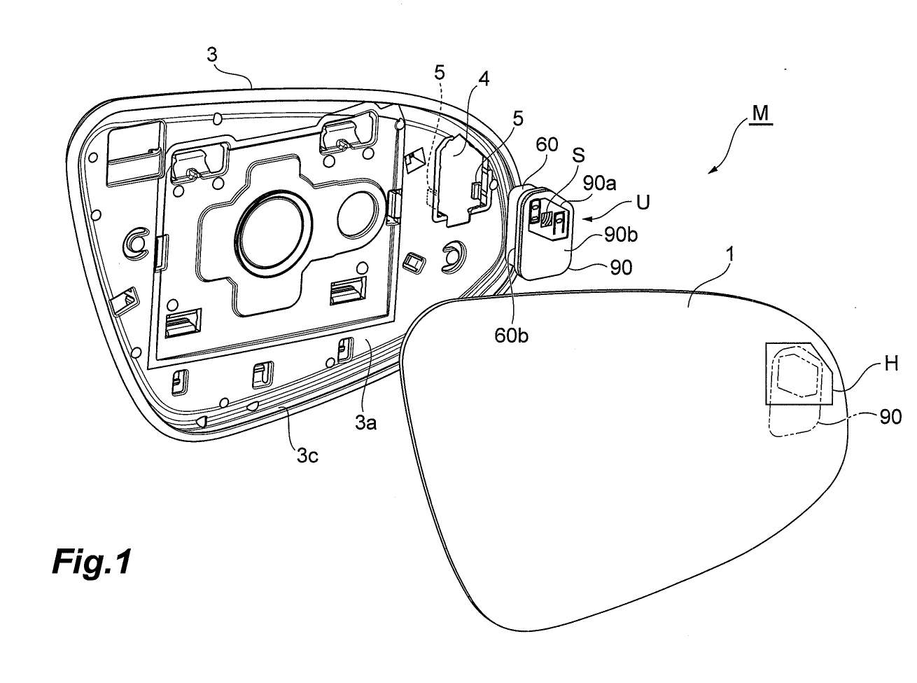

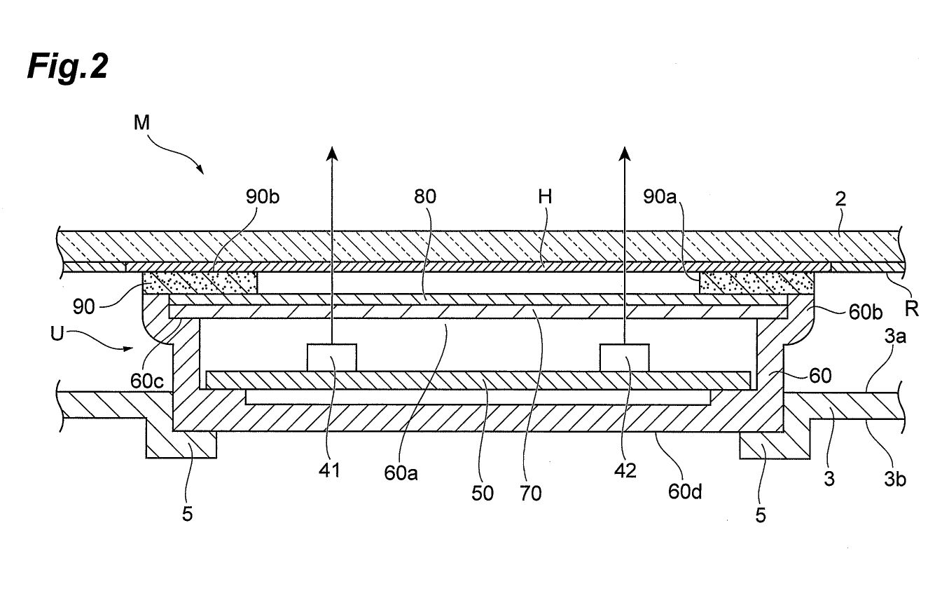

Referring to FIGS. 1 and 2, the door mirror for an automobile includes a reflective mirror 1 for viewing a rearward vehicle. The reflective mirror 1 is disposed so as to close an opening in a cup-shaped housing. A mechanism for moving the reflective mirror 1 is accommodated inside the housing. The reflective mirror 1 is transparent glass 2 having a back surface on which a reflective film R is vapor-deposited. The back surface of the reflective mirror 1 is covered in a resin mirror holder 3. A recess-shaped fit portion 3c in which a circumferential edge of the reflective mirror 1 is to be fitted is formed on a circumferential edge of the mirror holder 3. The reflective mirror 1 and the mirror holder 3 configure a mirror unit M.

In addition, a lamp unit U including a lead (not shown) is disposed on the back surface of the reflective mirror 1. A first light-emitting diode (LED) 41 and a second LED 42 for illuminating side object detection symbols S formed on a light exit surface are accommodated in the lamp unit U. Each of the first LED 41 and the second LED 42 is fixed on a circuit board 50 and the circuit board 50 is fixed inside a housing 60.

A light diffusing plate 70 is fixed to the housing 60 so as to close an opening 60a in the housing 60 of the lamp unit U. Each of the first LED 41 and the second LED 42 is accommodated in a space formed by the light diffusing plate 70 and the housing 60. A circumferential edge of the light diffusing plate 70 is held by an extended portion 60c of a flange portion 60b formed on the opening 60a side in the housing 60. Employing the light diffusing plate 70 allows the first and second LEDs 41, 42 to be disposed so as to be close to the side object detection symbols S, which enables the housing 60 to be built thinner.

Additionally, a sheet 80 on which the side object detection symbols S of an ISO standard are formed is fixed to a front surface of the light diffusing plate 70 and the side object detection symbols S are cut out to allow light to transmit. A back surface of a sheet-like cushion portion 90 is affixed to a front surface of the sheet 80. The cushion portion 90 has an opening 90a formed therein for exposing the side object detection symbols S. It is noted that adhesive is not provided on a front surface 90b of the cushion portion 90.

As such, the lamp unit U is formed to include the housing 60, the first LED 41, the second LED 42, the circuit board 50, the light diffusing plate 70, the sheet 80, and the cushion portion 90. Consequently, assembly workability is improved by unitizing a light source.

In addition, a half mirror portion H for transmitting light from the lamp unit U is formed on a back surface of the transparent glass 2 of the reflective mirror 1, with the reflective film R vapor-deposited on remaining areas. The half mirror portion H and the opening 90a in the cushion portion 90 face each other and the front surface 90b of the cushion portion 90 is pressed against the back surface of the reflective mirror 1.

The mirror holder 3 includes an opening portion 4 and a lamp unit receiving portion 5. The opening portion 4 allows the housing 60 of the lamp unit U to be dropped in from an inner surface 3a side of the mirror holder 3. The lamp unit receiving portion 5 is disposed near the opening portion 4. The lamp unit receiving portion 5 is tab portions protruding toward an outer surface 3b side of the mirror holder 3 as to be able to view from the opening portion 4 and is extremely simply arranged. A bottom surface 60d of the housing 60 of the lamp unit U is supported by a pair of oppositely disposed tab portions 5.

When the mirror unit M is to be assembled, the lamp unit U is dropped into the opening portion 4 formed in the mirror holder 3 from the inner surface 3a side of the mirror holder 3 in a condition in which the side object detection symbols S face upward; thereafter, the circumferential edge of the reflective mirror 1 is fitted into the recess-shaped fit portion 3c of the mirror holder 3. The lamp unit U is thus simply clamped and fixed between the lamp unit receiving portion (tab portions) 5 and the reflective mirror 1. When the lamp unit U is assembled in the mirror unit M, therefore, adhesive is not used, so that workability is extremely good.

Additionally, the front surface 90b of the cushion portion 90 is not provided with adhesive. This prevents a situation from occurring in which release paper is peeled off from the adhesive or the adhesive makes the lamp unit U sticky to hands, thus further improving assembly workability. Since the lamp unit U does not stick to the reflective mirror 1, reassembly sequence performed for the lamp unit U relative to the mirror unit M after inspection is made easy.

If the front surface 90b of the cushion portion 90 is provided with adhesive, the adhesive is to stick on the half mirror portion H. Since the adhesive and the half mirror portion H have different refractive indexes from each other, the adhesive is imaged on the half mirror portion H because of an interference effect of light involved, so that the adhesive is visible from an outside through the half mirror portion H. The application of the cushion portion 90 having no adhesive on the front surface 90b results in the cushion portion 90 being imaged extremely faintly even with the cushion portion 90 pressed against a back surface of the half mirror portion H, as shown by a dash-double-dot line in FIG. 1.

EPDM, in particular, is preferable for the material of the cushion portion 90 and a black or gray color exhibits an imaging reduction effect. It is preferable that the half mirror portion H have a light transmittance of 3 to 30% to prevent the cushion portion 90 from being seen through.

In addition, since the cushion portion 90 surrounds the side object detection symbols S through which light transmits, light can be reliably blocked and, moreover, water can be prevented from entering the side object detection symbols S to thereby allow the cushion portion 90 to offer a water stop effect. If the reflective mirror has a curved surface, the cushion portion 90 can be easily made to conform to the curved surface. Additionally, since the cushion portion 90 conforms to the curved surface, an identical lamp unit can still be used even if a reflective mirror having a different curvature is to be used.

It is to be understood that the present invention is not limited to the embodiment described above.

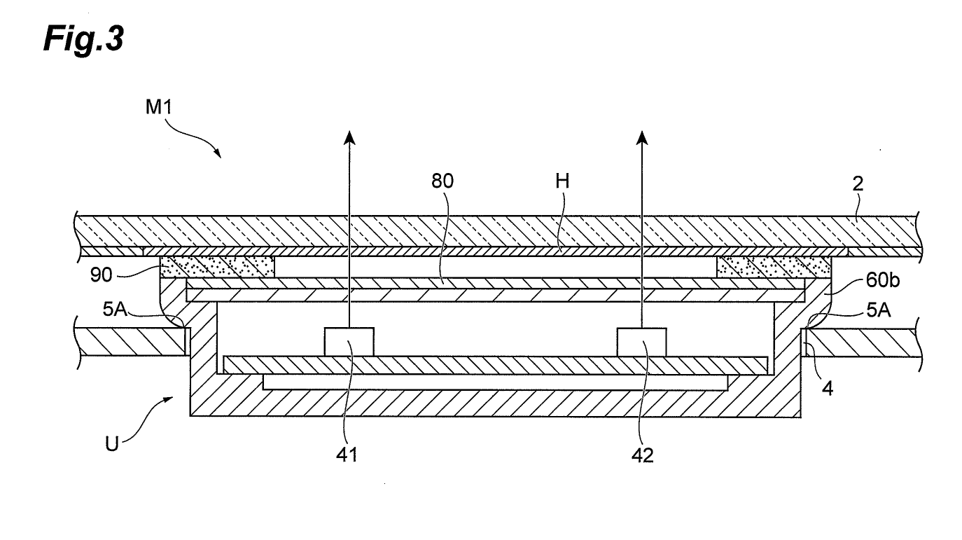

Referring to FIG. 3, in another mirror unit M1, a lamp unit receiving portion 5A may be an edge portion of an opening portion 4 on which a flange portion 60b formed on a lamp unit U touches.

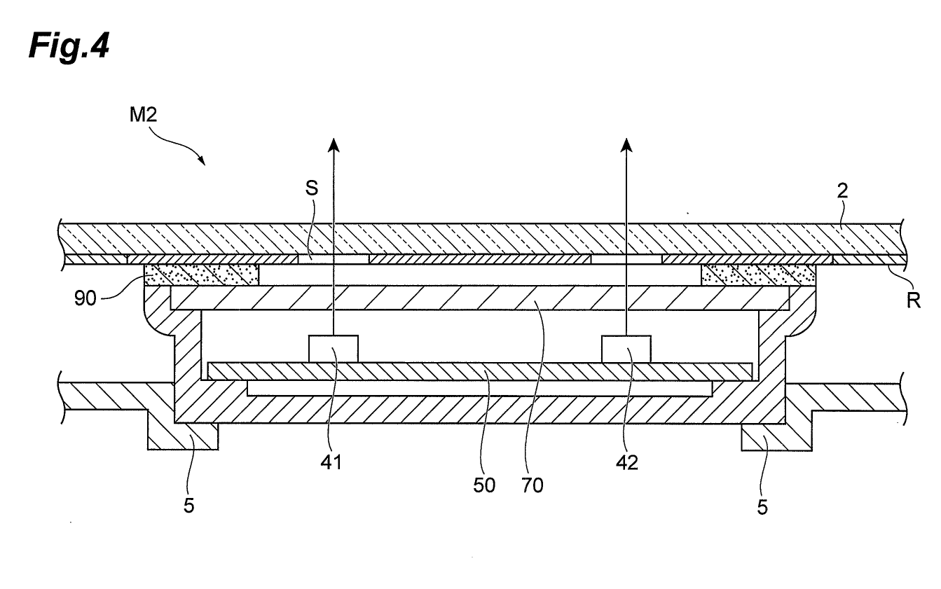

Referring to FIG. 4, in still another mirror unit M2, side object detection symbols S may be formed on a back surface of a reflective mirror 1 by peeling a reflective film R from transparent glass 2 through a blasting process or a laser etching process.

The rearview mirror according to the embodiment of the present invention can be applied to an inner mirror.

What is claimed is:

1. A rearview mirror comprising:
a mirror unit including a reflective mirror and a mirror holder disposed on the reflective mirror so as to cover a back surface of the reflective mirror in an inner surface side thereof; and
a lamp unit including a light emitting section inside a housing, wherein
the mirror holder includes an opening portion in which the housing of the lamp unit is dropped from the inner surface side of the mirror holder and a lamp unit receiving portion disposed near the opening portion;
the lamp unit is clamped and fixed between the lamp unit receiving portion and the reflective mirror; and
the lamp unit includes a cushion portion disposed on a light exit side, the cushion portion having a front surface pressed against the back surface of the reflective mirror by the mirror holder and the front surface of the cushion portion not provided with adhesive.

2. The rearview mirror according to claim 1, wherein the reflective mirror includes a half mirror portion, formed thereon, for transmitting light from the lamp unit, the lamp unit includes a display portion through which light transmits, and the cushion portion is disposed so as to surround the display portion and is pressed against a back surface of the half mirror portion of the reflective mirror.

3. The rearview mirror according to claim 1, wherein the lamp unit receiving portion on which a flange portion formed on the lamp unit touches corresponds to an edge portion of the opening portion.

4. The rearview mirror according to claim 1, wherein the lamp unit receiving portion for supporting a bottom surface of the housing of the lamp unit protrudes toward an outer surface side of the mirror holder as to be able to view from the opening portion.
